(19) United States
(12) Patent Application Publication
(10) Pub. No.: US 2005/0089600 A1
(43) Pub. Date: Apr. 28, 2005

(54) Chewing gum having extended flavor duration and methods for making same

(76) Inventors: Michael A. Reed, Merrillville, IN (US); Victor V. Gudas, Oak Lawn, IL (US); Kevin B. Broderick, Berwyn, IL (US); Marc A. Bernicky, Bolingbrook, IL (US); Michael J. Greenberg, Northbrook, IL (US); Philip Mazzone, Griffith, IN (US); Philip W. Urnezis, Lombard, IL (US); Michael T. Bunczek, Lisle, IL (US)

Correspondence Address: BELL, BOYD & LLOYD LLC, P. O. BOX 1135, CHICAGO, IL, 60690-1135, US

(21) Appl. No.: 10/987,481

(22) Filed: Nov. 12, 2004

Related U.S. Application Data
(63) Continuation of application No. 09/569,404, filed on May 12, 2000, now abandoned.
Application No. 09/569,404 is a continuation-in-part of application No. 09/350,576, filed on Jul. 9, 1999, now abandoned.

(51) Int. Cl. A23G 3/30

(52) U.S. Cl. 426/3

(57) ABSTRACT

Chewing gum having extended flavor release and methods of manufacturing same are provided. Additionally, the chewing gum may have a modified release rate for other of the components. The chewing gum includes a water soluble portion and a water insoluble portion. The chewing gum includes a liquid preblend of a vinyl polymer and a flavor.

### RELATED APPLICATION

This is a continuation-in-part of U.S. patent application Ser. No. 09/350,576, entitled “Chewing Gum Having Extended Flavor Duration and Methods for Making Same,” filed on Jul. 9, 1999.

### BACKGROUND OF THE INVENTION

The present invention relates generally to chewing gum. More specifically, the present invention relates to chewing gum having an extended flavor duration and methods for manufacturing same.

It is of course known to provide chewing gum formulations including a variety of different ingredients. Some of these ingredients add flavor or sweetness to the gum. These flavors and sweeteners are provided in a water soluble portion of the chewing gum. Accordingly, as the gum is chewed the flavors and/or sweeteners are released into the mouth of the chewer.

One of the issues in manufacturing and formulating chewing gum is to prolong the release of flavor and sweetness during the chew. It is desirable to extend the flavor and/or sweetness release for the longest possible time.

There have been many methods and formulations for treating flavors and sweeteners in chewing gum formulations in order to extend the release during the chew. These methods include encapsulation, absorption, or entrapment of the sweetener or flavor. Encapsulation of ingredients may also be desirable to avoid degradation of the ingredients during storage. Examples of the encapsulation of a sweetener are disclosed in U.S. Pat. Nos. 4,986,991; 5,108,762; 5,124,160; 5,139,798; 5,154,939; 5,165,944; 5,169,657; 5,169,658; 5,198,251; 5,229,148; 5,364,627; 5,413,799; 5,415,880; and 5,429,827; 5,116,626; and 5,173,317.

In attempting to prolong the release of flavors, typically methods are used that rely on a dry flavor system. These dry flavor systems modify the release rate of the flavor during the chew. For example, it has been known to mix flavors with polyvinyl acetate and form a solid matrix that is added to a chewing gum formulation. In this regard, reference is made to: U.S. Pat. Nos. 3,795,744; 3,826,847; 4,740,376; 4,992,280; 5,236,721; 5,458,891; 5,000,965; 4,933,190; 5,057,328; 4,386,106; 4,157,401; and WO 91/008678; WO 95/023519.

### SUMMARY OF THE INVENTION

The present invention provides chewing gums having improved release characteristics. For example, pursuant to the present invention, chewing gum having extended flavor release is provided. Additionally, pursuant to the present invention in embodiments, the release of hydrophobic cooling agents and/or sweeteners can be modified. Additionally, methods for producing such chewing gums are also provided.

To this end, a chewing gum formulation is provided that comprises a water soluble portion and a water insoluble gum base portion. The chewing gum formulation includes a liquid blend of a gum base vinyl polymer and a flavor.

In an embodiment, the vinyl polymer is chosen from the group consisting of: polyvinyl acetate; polyvinyl stearate; polyvinyl butyrate; polyvinyl propionate; polyvinyl alkanoates; copolymers of vinylacetate, vinyllaurate, or vinylacetate and vinylalkanoates; and polymers of ethylene-vinyl acetate, butylene-vinylacetate, and other alkenyl-vinylacetates.

In an embodiment, the blend comprises a ratio of vinyl polymer to flavor of approximately 1:4 to about 4:1.

In an embodiment, the vinyl polymer is a polyvinyl acetate having a molecular weight of approximately 10,000 to about 80,000.

In an embodiment, the flavor is a fruit flavor.

In an embodiment, the flavor is a mint flavor.

In an embodiment, the flavor is a cinnamon flavor.

Additionally, the present invention provides a flavor blend that can be added to other chewing gum ingredients. To this end a liquid flavor blend is provided comprising a blend of a flavor and a vinyl polymer.

In a further embodiment, the vinyl polymer is chosen from the group consisting of: polyvinyl acetate; polyvinyl stearate; polyvinyl butyrate; polyvinyl propionate; polyvinyl alkanoates; copolymers of vinylacetate, vinyllaurate, or vinylacetate and vinylalkanoates; and polymers of ethylene-vinyl acetate, butylene-vinylacetate, and other alkenyl-vinylacetates.

In an embodiment, the ratio of the vinyl polymer to flavor in the blend is approximately 1:4 to 4:1.

In an embodiment, the flavor is chosen from the group consisting of fruit flavors and mint flavors.

In an embodiment, the vinyl polymer is polyvinyl acetate having a molecular weight of approximately 50,000 to about 80,000 and the polyvinyl acetate comprises not more than 40% of the blend.

In an embodiment, the polyvinyl acetate has a molecular weight of approximately 10,000 to about 25,000 and the polyvinyl acetate comprises not more than 60% of the blend.

In an embodiment, the gum base ingredient is polyvinyl acetate and the flavor is a fruit ester.

In another embodiment, a method for producing chewing gum having an extended flavor duration is provided comprising the steps of: preblending a flavor with a vinyl polymer to form a liquid preblend; and adding the liquid preblend to the remaining chewing gum ingredients.

In an embodiment of the method, the preblend is added to a gum base portion.

In an embodiment of the method, a method of manufacturing chewing gum in a continuous process is used.

In an embodiment, an extruder is used to mix the ingredients.

In another embodiment, a method for producing chewing gum having a modified release of at least one of a hydrophobic cooling agent or sweetener is provided comprising the steps of: preblending a flavor with a vinyl polymer and at least a hydrophobic cooling agent or sweetener to form a liquid preblend; and adding the liquid preblend to remaining chewing gum ingredients.

In an embodiment, the sweetener is chosen from the group consisting of: acesulfame, alitame, saccharin, cyclamates, glycyrrhizin, dihydrochalcones, perillartine, thaumatin and monellin.

In an embodiment, the blend includes a hydrophobic cooling agent.

It is an advantage of the present invention to provide an improved chewing gum formulation.

Another advantage of the present invention is that it provides an improved method for manufacturing chewing gums.

An advantage of the present invention is to provide a method for modifying the release rate of certain ingredients from chewing gum.

Additionally, an advantage of the present invention is that it provides a chewing gum product having extended flavor release duration.

Still further, an advantage of the present invention is that it provides a new method for creating a flavor release system.

Further, an advantage of the present invention is to provide a chewing gum having a modified release note of at least a hydrophobic cooling agent or sweetener.

Moreover, an advantage of the present invention is that it provides a liquid based flavor release system.

Furthermore, an advantage of the present invention is to provide a system for extending the release rate of flavor from a chewing gum that can be easily incorporated into manufacturing processes for gum base or chewing gum.

Additional features and advantages of this present invention are described in, and will be apparent from, the detailed description of the presently preferred embodiments.

### DETAILED DESCRIPTION OF THE PRESENTLY PREFERRED EMBODIMENTS

The present invention provides improved chewing gum formulations and methods of manufacturing same. Pursuant to the present invention, a chewing gum is provided that has an extended flavor release duration. The extended flavor release duration is achieved by preparing a liquid preblend of at least one base ingredient and a flavor. This liquid preblend is added to the remaining ingredients of the chewing gum formulation. It has been found that the preblend provides a system which enhances the release rate of the flavor from the chewing gum during the chew.

To this end, it has been surprisingly found that by preparing a liquid preblend comprising flavor and a vinyl polymer base ingredient, that the preblend when added to the remaining chewing gum ingredients affords a resultant chewing gum that has significantly longer lasting flavor.

It has additionally been found that the release rate of other chewing gum ingredients can also be modified. Pursuant to the present invention, the release rate of hydrophobic cooling agents and sweeteners when added to the inventive preblend may also be modified.

To create the preblend, the flavor functions as a solvent and is blended with one of several base ingredients. Specifically, at least one vinyl polymer is used in the preblend. It has also been found that “new” polymer base components may be added to a flavor to create the liquid preblend. These base components include: polyvinyl acetate; polyvinylstearate; polyvinylbutyrate; polyvinyl propionate; polyvinyl laurate and other polyvinylalkanoates; ethylene-vinyl acetate; butylene-vinylacetate; and other alkenyl-vinylacetate.

The vinyl polymers are dissolved in the flavor to make a liquid preblended mixture. The liquid preblend is then added to the other gum ingredients. Vinyl polymers are dissolved in a flavor to create a liquid preblend that will provide longer lasting flavor. Preferably, the preblend is added to the gum base during the later stages of base manufacturing or just before the addition of the other gum ingredients. The preblend may be used in a continuous process for manufacturing chewing gum. Preferably, the preblend comprises a ratio of base ingredients to flavor of approximately 1:4 to 4:1.

By way of example, PVAc can be dissolved directly into a flavor such as cinnamic aldehyde at a ratio of about 1:4 to about 4:1, preferably the ratio is about 1:2 to about 2:1, and most preferably about 2:3 or 40% PVAc to 60% flavor, e.g., cinnamic aldehyde. If a high molecular weight PVAc of about 50,000 to 80,000 is used a higher ratio of flavor to PVAc is necessary. Whereas when a lower molecular weight PVAc of about 10,000 to 25,000 is used a lower ratio of flavor to PVAc is necessary. For medium molecular weight PVAc of 25,000 to 50,000, a ratio of 40% PVAc and 60% flavor, e.g., cinnamic aldehyde, is most preferable. In certain instances, high ratios of PVAc to flavor, such as 2:1 to 3:1, very low molecular weight PVAc from 4,000-10,000 may be used.

Chewing gums using high molecular weight PVAc have a tendency to be firmer than gums with low molecular weight PVAc. Also high molecular weight PVAc provides a more viscous mixture than low molecular weight PVAc. However, whether high or low molecular weight PVAc is used, both mixtures will provide chewing gum having a longer lasting flavor.

Generally, low or medium molecular weight PVAc may be preferred with most types of fruit flavors. PVAc has been found to readily dissolve in fruit esters as well as cinnamic aldehyde. If a fruit flavor contains cinnamic aldehyde, a combination of esters with cinnamic aldehyde may be used to dissolve PVAc to obtain longer lasting flavor.

It was found that vinyl polymers provide advantages when combined with flavor to form the liquid preblend as compared to other “base ingredients.” Base elastomers, elastomer plasticizers and terpene resins are hydrophobic materials that are generally referred to as hydrocarbon polymers. These polymers are non-polar, and are very compatible and soluble in mint-type flavors. Mint oils, such as spearmint and peppermint, contain mono- and sesquiterpenes, which are also hydrocarbons. Compared to the other “base ingredients”, polyvinyl acetate and vinyl polymers are much less hydrophobic, are more polar, and are much less compatible and soluble in mint flavors.

This difference in compatibility is very important when preparing the base/flavor preblend. The ratio of polymer to flavor in the flavor/base preblend should be at least 1:4 or 20% polymer. The more soluble the polymer is in the flavor, the more effect the preblend will have on modifying the flavor release. Also, more soluble polymers can allow for a higher usage level of polymer to be dissolved in the flavor for better effectiveness. Terpene resins and elastomer plasticizers are readily soluble in mint flavors and can be easily dissolved at a level of over 20%, but polyvinyl acetate is not as soluble, and cannot be dissolved in peppermint flavor at these high levels. Although not as readily as terpene resins, polyvinyl acetate can be dissolved in spearmint flavor, which also contains a high level of carvone.

Polyvinyl acetate and vinyl polymers are also more compatible and more soluble in flavors that contain mostly oxygenated (non-hydrocarbon) components, such as flavor aldehydes and flavor esters. These components in these flavors will readily dissolve polyvinyl acetate and vinyl polymers at the higher levels of polymer to flavor. This is needed for the preblend to have a significant effect. In Example 5 set forth hereinafter, terpene resin could not be dissolved in sufficiently high level in the acetate esters, so orange oil, which contains high levels of terpenes, was added to make a soluble preblend.

Vinyl polymers that contain a side chain having a low molecular weight, such as acetate, propionate, or butyrate will be more compatible with flavor aldehydes and flavor esters, whereas a side chain having a larger molecular weight, such as laurate, or stearate will improve the compatibility (hydrophobicity) of these types of vinyl polymers with mint oils and mint flavor. Copolymers that contain both low and high molecular weight side chains such as a copolymer of vinyl acetate and vinyl laurate will give the advantages of compatibility in both mint type flavors and aldehyde/ester type flavors.

Polyvinyl acetate (PVAc) and vinyl polymers that are very low in molecular weight can also be preblended with both mint oils and aldehyde/ester-type flavors. Standard molecular weights for polyvinyl acetate used in gum base are low, medium, and high, which are 10,000-25,000, 25,000-50,000, and 50,000-80,000, respectively. Very low molecular weight PVAc of about 4,000-10,000 is unique in that its molecular weight is low enough to make it more soluble in aldehyde/ester flavors, but also improves its compatibility with mint oils and allows a higher level of use in a PVAc/mint flavor preblend.

Another example is a flavor such as methyl salicylate. This ingredient could be used to dissolve PVAc and used in gum to provide longer lasting quality of wintergreen type flavors. PVAc would be preferred as the base ingredient, since other resins like terpene resins would probably not dissolve in methyl salicylate.

As noted above, other new polymer base components may be added to the flavors and used in gum to give longer lasting flavor duration. These new components can also modify the flavor quality over time. Such other vinyl polymers include: polyvinylstearate, polyvinylbutyrate, polyvinyl propionate and other polyvinylalkanoates. Also copolymers of vinylacetate and vinyllaurate or vinylacetate and vinylalkanoates as well as other polymers such as ethylene-vinyl acetate, butylene-vinylacetate, and other alkenyl-vinylacetate may be dissolved in the flavors and added to gum for flavor duration. Of particular usefulness is a copolymer of vinyl acetate and 40% vinyl laurate.

There are additional advantages to using vinyl polymers dissolved in flavors prior to delivery into chewing gum. It appears that the liquid mixture does not degrade or oxidize as quickly as the flavor does by itself.

Another advantage for using base/flavor preblends is that not only is the flavor released differently, but hydrophobic cooling agents and sweeteners when added to the preblended flavor/base mixture can have a modified release from gum. High intensity sweeteners such as salts of acesulfame, alitame, saccharin, cyclamates, glycyrrhizin, perillartine, dihydrochalcones, thaumatin, and monellin may be added to the preblend.

A particularly good sweetener is a lipophillic sweetener called Perillartine. This sweetener is very soluble in mint oils and aldehyde ester flavors; many high intensity sweeteners such as alitame and sucrolose are more soluble in flavor esters and not soluble in mint oils. The sweetener effectively sweetens the later flavor release from the gum.

Also, lipophillic cooling agents may be added to the flavor/base mixture preblend. Cooling agents such as substituted p-menthane carboxamides, acyclic carboxamides, methone glycerol ketal, menthyl lactate, menthyl succinate, and 3-1 menthoxypropane-1,2-diol, when added to the preblend before being added to the gum composition can have an effect on the release of the cooling agent. High intensity cooling agents are soluble in both mint oils and esters.

The chewing gum that can utilize the present invention may be any of a variety of different chewing gums.

Chewing gum generally consists of a water insoluble gum base, a water soluble portion, and flavors. The water soluble portion dissipates with a portion of the flavor over a period of time during chewing. The gum base portion is retained in the mouth throughout the chew.

The insoluble gum base generally comprises elastomers, resins, fats and oils, softeners, and inorganic fillers. The gum base may or may not include wax. The insoluble gum base can constitute approximately 5 to about 95 percent, by weight, of the chewing gum, more commonly, the gum base comprises 10 to about 50 percent of the gum, and in some preferred embodiments, 20 to about 35 percent, by weight, of the chewing gum.

In an embodiment, the chewing gum base of the present invention contains about 20 to about 60 weight percent synthetic elastomer, 0 to about 30 weight percent natural elastomer, about 5 to about 55 weight percent elastomer plasticizer, about 4 to about 35 weight percent filler, about 5 to about 35 weight percent softener, and optional minor amounts (about one percent or less) of miscellaneous ingredients such as colorants, antioxidants, etc.

Synthetic elastomers may include, but are not limited to, polyisobutylene with a GPC weight average molecular weight of about 10,000 to about 95,000, isobutylene-isoprene copolymer (butyl elastomer), styrene-butadiene copolymers having styrene-butadiene ratios of about 1:3 to about 3:1, polyvinyl acetate having a GPC weight average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred ranges are, for polyisobutylene, 50,000 to 80,000 GPC weight average molecular weight, for styrene-butadiene, 1:1 to 1:3 bound styrene-butadiene, for polyvinyl acetate, 10,000 to 65,000 GPC weight average molecular weight with the higher molecular weight polyvinyl acetates typically used in bubble gum base, and for vinyl acetate-vinyl laurate, vinyl laurate content of 10-45 percent.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing, the preferred elastomer plasticizers will also vary depending on the specific application, and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof. Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The water soluble portion can include bulk sweeteners, high intensity sweeteners, flavoring agents, softeners, emulsifiers, colors, acidulants, fillers, antioxidants, and other components that provide desired attributes.

Softeners are added to the chewing gum in order to optimize the chewability and mouth feel of the gum. The softeners, which are also known as plasticizers and plasticizing agents, generally constitute between approximately 0.5 to about 15% by weight of the chewing gum. The softeners may include glycerin, lecithin, and combinations thereof. Aqueous sweetener solutions such as those containing sorbitol, hydrogenated starch hydrolysates, corn syrup and combinations thereof, may also be used as softeners and binding agents in chewing gum.

Bulk sweeteners include both sugar and sugarless components. Bulk sweeteners typically constitute 5 to about 95% by weight of the chewing gum, more typically, 20 to 80% by weight, and more commonly, 30 to 60% by weight of the gum.

Sugar sweeteners generally include saccharide-containing components commonly known in the chewing gum art, including, but not limited to, sucrose, dextrose, maltose, dextrin, dried invert sugar, fructose, levulose, galactose, corn syrup solids, and the like, alone or in combination.

Sugarless sweeteners include, but are not limited to, sugar alcohols such as sorbitol, mannitol, xylitol, hydrogenated starch hydrolysates, maltitol, and the like, alone or in combination.

High intensity artificial sweeteners can also be used in combination with the above. Preferred sweeteners include, but are not limited to sucralose, aspartame, salts of acesulfame, alitame, saccharin and its salts, cyclamic acid and its salts, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8%. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Example of low calorie bulking agents include: polydextrose; Raffilose; Raftilin; Fructooligosaccharides (NutraFlora); Palatinose oligosacchardie; Guar Gum Hydrolysate (Sun Fiber); or indigestible dextrin (Fibersol). However, other low calorie bulking agents can be used.

The flavors pursuant to the present invention are, at least in part, added to the other chewing gum components as a liquid preblend with a base ingredient. Flavor should generally be present in the chewing gum in an amount within the range of about 0.1-15% by weight of the chewing gum, preferably between about 0.2-5% by weight of the chewing gum, mostly preferably between about 0.5-3% by weight of the chewing gum. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used in the flavor ingredient of the invention. Natural and artificial flavoring agents may be combined in any sensorially acceptable fashion.

Optional ingredients such as colors, emulsifiers, pharmaceutical agents and additional flavoring agents may also be included in chewing gum.

The present invention, it is believed, can be used with a variety of processes for manufacturing chewing gum. Included are conventional processes as described below as well as continuous processes for gum mixing or base and gum mixing. Continuous processes are described in the Examples.

Chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, extruding into chunks, or casting into pellets.

Generally, the ingredients are mixed by first melting the gum base and adding it to the running mixer. The gum base may alternatively be melted in the mixer. Color and emulsifiers can be added at this time.

A chewing gum softener such as glycerin can be added next along with part of the bulk portion. Further parts of the bulk portion may then be added to the mixer. Flavoring agents are typically added with the final part of the bulk portion. The entire mixing process typically takes from five to fifteen minutes, although longer mixing times are sometimes required.

By way of example, and not limitation, examples of the present invention will now be given.

### EXAMPLE NOS. 1-3

Laboratory samples of experimental gums made by a conventional process were prepared according to the following formulations to test liquid blends of cinnamic aldehyde with low, medium and high molecular weight PVAc;

| | % | | | | Comp |
|---|---|---|---|---|---|
| | Comp A | Ex 1 | Ex 2 | Ex 3 | B |
| Base | 19.95 | 19.95 | 19.95 | 19.95 | 19.95 |
| Sugar | 61.49 | 60.49 | 60.49 | 60.49 | 60.99 |
| Corn Syrup | 15.78 | 15.78 | 15.78 | 15.78 | 15.78 |
| Glycerin | 0.99 | 0.99 | 0.99 | 0.99 | 0.99 |
| Red Color | 0.38 | 0.38 | 0.38 | 0.38 | 0.38 |
| Cinnamon Flavor | 1.41 | 1.41 | 1.41 | 1.41 | 1.41 |
| 1:1 High MW PVAc:CA | | 1.00 | | | |
| 1:1 Medium MW PVAc:CA | | | 1.00 | | |
| 1:1 Low MW PVAc:CA | | | | 1.00 | |
| CA neat | | | | | 0.50 |

Examples 1-3 were prepared by first making the cinnamic aldehyde blend and premixing it with the base in a separate mixer prior to making gum. Bench level screening found the medium molecular weight PVAc and high molecular weight PVAc blends to have superior duration and minimal texture impact upon the finished product. Low molecular weight PVAc was also found to be effective but tended to have too strong of an initial release. Medium molecular weight PVAc:CA blend was preferred since the higher molecular weight PVAc:CA blend was more difficult to make and was significantly higher in viscosity.

Comparison B was run with cinnamic aldehyde added neat. There was no improvement in duration with an unacceptably strong early heat level.

Although the flavor/base ingredient blend can be added to gum base in gum in a conventional mixing process as in Examples 1-3, it is most preferred the blends in a continuous base and gum mixing process. Continuous base and gum mixing processes are described in U.S. Pat. Nos. 5,543,160 and 5,612,017.

### EXAMPLE 4

A cinnamon flavored sugar gum process is described in Example Nos. 1-4 in U.S. Pat. No. 5,612,071 and is used to make the following formulation for base and gum.

Base

| | lbs./hr. | % |
|---|---|---|
| 1. Isopene-isobutylene copolymer | 7.395 | 7.50 |
| 2. Polyisobutylene | 4.891 | 4.96 |
| 3. Glycerol Ester of wood rosin | 7.742 | 7.86 |
| 4. Glycerol Ester of gum rosin | 7.741 | 7.86 |
| 5. Medium MW PVAc | 10.181 | 10.33 |
| 6. Fat/Oil Mixture | 22.710 | 23.04 |
| 7. Calcium carbonate | 37.893 | 38.45 |
| | 98.553 | 100.00 |

As discussed in U.S. Pat. No. 5,612,071 polymers 1 and 2 are preblended with some calcium carbonate and some of rosin 3 and 4 in the first zone of the mixer. In the next mixer zone, the remainder of the rosins, PVAc, and the remainder of calcium carbonate is added. The fat/oil mixture as formulated in U.S. Pat. No. 5,612,071 is added at the third zone along with the PVAc/cinnamic aldehyde liquid blend as described in the gum formula below:

Gum

| | lbs./hr. | % |
|---|---|---|
| Base | 98.553 | 20.75 |
| Sugar | 280.478 | 59.05 |
| 39 DE, 45 Be Syrup** | 74.960 | 15.78 |
| Glycerin | 5.690 | 1.20 |
| 40/60 PVAc/CA blend | 6.650 | 1.40 |
| Cinnamin Flavor | 4.750 | 1.00 |
| 10% Salt Solution** | 0.475 | 1.00 |
| Color | 0.360 | 0.07 |
| Encapsulated High | 2.612 | 0.55 |
| Intensity Sweeteners | | |
| Lecithin* | 0.472 | 0.10 |
| | 475.000 | 100.00 |

*This amount of lecithin is preblended with the fat/oil mixture given above.
**Syrup and salt solution are preblended and added together.

In the process, glycerin, and color are added in the fourth zone and all other ingredients' added in the fifth zone. The gum formula gave an improved longer lasting flavor compared to the same formula without preblending cinnamic aldehyde with PVAc. Terpene resins may be dissolved in orange oil or other components of essential oils, such as shown in Example 6.

### EXAMPLE NO. 5

A fruit flavored sugar chewing gum was made by continuous mixer by a process similar to Example 6 of U.S. Pat. No. 5,543,160 according to the following base and gum formula.

Base

| | lbs./hr. | % |
|---|---|---|
| 1. Isopene-isobutylene copolymer | 5.845 | 5.86 |
| 2. Polyisobutylene | 2.458 | 2.46 |
| 3. Glycerol Ester of wood rosin | 8.020 | 8.04 |
| 4. Terpene resin | 8.127 | 8.15 |
| 5. Low MW PVAc | 11.767 | 11.80 |
| 6. Medium MW PVAc | 16.039 | 16.08 |
| 7. Calcium carbonate | 34.886 | 34.97 |
| 8. Glycerol monostearate | 8.020 | 8.04 |
| 9. Lecithin | 4.063 | 4.07 |
| 10. Color | 0.482 | 0.48 |
| 11. BHT | 0.045 | 0.05 |
| | 99.752 | 100.00 |

Materials 1 and 2 which were preblended with some calcium carbonate were added in zone 1 along with some of material 3. In zone 2, materials 4, 5, and 6 were added with the remaining calcium carbonate and the remaining material 3. In zone 3, the other remaining materials, 8, 9, 10 and 11 were added along with a preblended terpene resin/flavor liquid mixture having a 6:2:1 ratio of terpene resin:acetate esters:orange oil as shown in the following gum formula.

Gum

| | lbs./hr. | % |
|---|---|---|
| Base | 99.750 | 21.00 |
| Sugar | 317.502 | 66.84 |
| 39 DE, 45 Be Syrup | 42.393 | 8.92 |
| Fruit Flavor | 6.359 | 1.34 |
| Terpene/flavor blend | 4.710 | 0.99 |
| Glycerin | 2.355 | 0.50 |
| Triacetin | 0.942 | 0.20 |
| Encapsulated Sweeteners | 0.989 | 0.21 |
| | 475.000 | 100.00 |

The glycerin and triacetin were added in zone 4 and the other remaining ingredients in zone 5 as described in U.S. Pat. No. 5,543,160. The gum formulation had an improved longer lasting full bodied flavor compared to the same formula made without preblending esters and orange oil with terpene resins.

### EXAMPLE NO. 6

A peppermint flavored sugar chewing gum was made by a continuous process as disclosed in Example 5 of U.S. Pat. No. 5,543,160 according to the following base and gum formulations.

Base

| | lbs./hr. | % |
|---|---|---|
| 1. Isopene-isobutylene copolymer | 7.084 | 36.10 |
| 2. Polyisobutylene | 3.559 | 3.57 |
| 3. Calcium Carbonate | 36.006 | 36.10 |
| 4. Terpene resin | 13.622 | 13.65 |
| 5. Low MW PVAc | 19.620 | 19.67 |
| 6. Glycerol Monostearate | 3.931 | 3.94 |
| 7. Hydrogenated cottonseed oil | 6.321 | 6.33 |
| 8. Hydrogenated soybean oil | 3.712 | 3.72 |
| 9. Partially hydrogenated soybean oil | 2.613 | 2.62 |
| 10. Lecithin | 2.729 | 2.74 |
| 11. Color | 0.499 | 0.50 |
| 12. BHT | 0.056 | 0.06 |
| | 99.25 | 100.00 |

Materials 1 and 2 were preblended with some of the calcium carbonate and added in zone 1. In zone 2, materials 4 and 5 with the remaining calcium carbonate were added. Materials 6 through 12 were melted and preblended together and added in zone 3. Also added in zone 3 was a liquid mixture of terpene resins: menthol; menthone in a ratio of 3:2:1 as shown in the following gum formula.

Gum

| | lbs./hr. | % |
|---|---|---|
| Base | 99.750 | 21.00 |
| Sugar | 319.917 | 67.35 |
| 39 DE, 45 Be Syrup | 40.850 | 8.60 |
| Glycerin | 5.700 | 1.20 |
| Peppermint Flavor | 3.800 | 0.80 |
| Terpene resin/menthol/menthone blend | 1.900 | 0.40 |
| 10% salt solution | 0.475 | 0.10 |
| Encapsulated high intensity sweeteners | 2.608 | 0.55 |
| | 475.000 | 100.00 |

The sugar, glycerin, high intensity sweetener blend, and the preblend of syrup and salt solution were added in zone 5 along with the flavor being added last. The example gave a chewing gum that had a cool, refreshing long lasting flavor compared to a gum formula that did not have the resin/flavor ingredients preblended.

### EXAMPLE NOS. 7-10

Three gum compositions were made with various base/flavor compositions using the following gum formulation:

| | Example 7 | Example 8 | Example 9 | Example 10 |
|---|---|---|---|---|
| Gum Base | 19.65% | 19.65% | 19.65% | 19.65% |
| Sugar | 54.7% | 53.9% | 54.4% | 53.9% |
| 39 DE Syrup | 13.3% | 13.3% | 13.3% | 13.3% |
| Dextrose Monohydrate | 9.9% | 9.9% | 9.9% | 9.9% |
| Glycerin | 1.3% | 1.3% | 1.3% | 1.3% |
| Lecithin | 0.25% | 0.25% | 0.25% | 0.25% |
| Flavor | 0.9% | — | — | — |
| 1/1 PVS/flavor | — | 1.8% | — | — |
| 1/3 PVAc-VL/flavor | — | — | 1.2% | — |
| 1/1 PVAc/flavor | — | — | — | 1.8% |

In the examples above:

Example 7 was a comparison example that contained 0.9% peppermint flavor.

Example 8 was an experimental example that contained a 1:1 liquid mixture of polyvinylstearate:peppermint flavor.

Example 9 was an experimental example that contained a 1:3 liquid mixture of a vinyl acetate-vinyl laurate copolymer:peppermint flavor.

Example 10 contained a 1:1 liquid mixture of very low MW PVAc:peppermint flavor. Very low MW PVAc has a molecular weight of 4000 to about 10,000.

Sensory tests of these samples indicated that the polymer/flavor blend provided an improved flavor quality having less cooling and harshness and had a longer duration. In addition, very low MW PVAc was dissolved in peppermint flavor up to 60% PVAc and provided a viscous solution.

### EXAMPLE NOS. 11-15

The following examples were made using preblends of peppermint flavor with a poly(vinyl acetate-40% vinyl laurate) copolymer and a cooling agent and sweetener.

In Example 11, Blend A was a preblend of 25% of the copolymer and 75% peppermint flavor.

In Example 12, Blend B was a preblend of 22.7% copolymer, 67.9% peppermint flavor, and 9.4% a cooling agent N-2,3-trimethyl-2-isopropyl butanamide.

In Example 13, Blend C was a preblend of 23.9% copolymer, 73.2% peppermint flavor, and 2.9% Perillartine sweetener.

In Example 14, Blend D was a preblend of 22.4% copolymer, 72.4% peppermint flavor, 2.9% Perillartine sweetener, and 2.3% of N-2,3-trimethyl-2-isopropyl butauamide.

In Example 15, Blend E was added to the composition. Blend E was a preblend of 59.7% cooling agent, 24.1% methylbutyraldehyde, a component of peppermint oil, and 16.2% of very low molecular weight PVAc.

| | Ex. 11 | Ex. 12 | Ex. 13 | Ex. 14 | Ex. 15 |
|---|---|---|---|---|---|
| Gum Base | 18.75% | 18.75% | 18.75% | 18.75% | 18.75% |
| Sugar | 52.75% | 52.44% | 52.45% | 52.11% | 52.32% |
| 39 DE Syrup | 12.72% | 12.72% | 12.72% | 12.72% | 12.72% |
| Dextrose Monohydrate | 9.45% | 9.45% | 9.45% | 9.45% | 9.45% |
| Encapsulated APM | 3.26% | 3.26% | 3.26% | 3.26% | 3.26% |
| Glycerin | 1.23% | 1.23% | 1.23% | 1.23% | 1.23% |
| Lecithin | 0.24% | 0.24% | 0.24% | 0.24% | 0.24% |
| Peppermint Flavor | 0.40% | — | — | — | 1.73% |
| Blend A | 1.20% | — | — | — | |
| Blend B | — | 1.91% | — | — | — |
| Blend C | — | — | 1.90% | — | — |
| Blend D | — | — | — | 2.24% | — |
| Blend E | — | — | — | — | 0.30% |

Sensory evaluations of Examples 11-15 demonstrated that peppermint flavor had a milder coolness, less harshness from the flavor, and a longer flavor duration with the preblends. In the Examples with Perillartine, the formulations had an improved late sweetness along with a longer lasting flavor. In the examples where the cooling agent was preblended with the base/flavor preblend, there was a faster release of cooling compared to a sample where the cooling agent was mixed with the flavor only.

Analytical tests have shown that cooling agents are released faster when preblended with base/flavor preblend than when added to the flavor directly.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A chewing gum formulation comprising:
a water insoluble gum base portion;
a water soluble portion; and
a liquid blend of a flavor and a vinyl polymer chosen from the group consisting of: polyvinyl acetate; polyvinyl stearate; polyvinyl butyrate; polyvinyl propionate; polyvinyl alkanoates; copolymers of vinylacetate, vinyllaurate, vinylacetate and vinylalkanoates; and polymers of ethylene-vinyl acetate, butylene-vinylacetate, and other alkenyl-vinylacetates.

2. The chewing gum of claim 1 wherein the flavor is cinnamon aldehyde and the vinyl polymer is polyvinyl acetate.

3. The chewing gum of claim 1 wherein the blend comprises a ratio of vinyl polymer to flavor of approximately 1:4 to about 4:1.

4. The chewing gum of claim 1 wherein the vinyl polymer is polyvinyl acetate having a molecular weight of approximately 10,000 to about 80,000.

5. The chewing gum of claim 1 wherein the vinyl polymer is polyvinyl acetate having a molecular weight of approximately 4,000 to about 10,000.

6. The chewing gum of claim 1 wherein the flavor is a fruit ester and the vinyl polymer is polyvinyl acetate.

7. The chewing gum of claim 1 wherein the vinyl polymer includes a copolymer of vinyl acetate and vinyl laurate.

8. The chewing gum of claim 1 wherein the blend includes a sweetener.

9. The chewing gum of claim 8 wherein the sweetener is chosen from the group consisting of: acesulfame; alitame; saccharin; cyclamates; glycyrrhizin; perillartine dihydrochalcones; thaumatin; and monellin.

10. The chewing gum of claim 1 wherein the blend includes a hydrophobic cooling agent.

11. A liquid flavor blend comprising a blend of a flavor and a gum base ingredient chosen from the group consisting of: polyvinyl acetate; polyvinyl stearate; polyvinyl butyrate; polyvinyl propionate; polyvinyl alkanoates; copolymers of vinylacetate, vinyllaurate, vinylacetate and vinylalkanoates; and polymers of ethylene-vinyl acetate, butylene-vinylacetate, and other alkenyl-vinylacetates.

12. The liquid flavor blend of claim 11 wherein the ratio of gum base ingredient to flavor is approximately 1:4 to 4:1.

13. The liquid flavor blend of claim 11 wherein the flavor is chosen from the group consisting of fruit flavors and aldehyde flavors.

14. The liquid flavor blend of claim 11 wherein the gum base ingredient is polyvinyl acetate having a molecular weight of approximately 50,000 to about 80,000 and the polyvinyl acetate comprises not more than 40% of the blend.

15. The liquid flavor blend of claim 11 wherein the gum base ingredient is polyvinyl acetate having a molecular weight of approximately 10,000 to about 25,000 and the polyvinyl acetate comprises not more than 60% of the blend.

16. The liquid flavor blend of claim 11 wherein the gum base ingredient is polyvinyl acetate and the flavor is a fruit ester.

17. The liquid flavor blend of claim 11 wherein the gum base ingredient is a terpene resin and the flavor is at least one component of mint oil.

18. The chewing gum of claim 11 wherein the blend includes a sweetener.

19. The chewing gum of claim 18 wherein the sweetener is chosen from the group consisting of: acesulfame; alitame; saccharin; cyclamates; glycyrrhizin; perillartine; dihydrochalcones; thaumatin; and monellin.

20. The chewing gum of claim 11 wherein the blend includes a hydrophobic cooling agent.

21. A method for producing chewing gum having an extended flavor duration comprising the steps of:
preblending a flavor with a vinyl polymer to form a liquid preblend; and
adding the liquid preblend to remaining chewing gum ingredients.

22. The method of claim 21 wherein the preblend is added to a gum base portion.

23. The method of claim 21 wherein a method of manufacturing chewing gum in a continuous process is used.

24. The method of claim 23 wherein the ratio of flavor to the vinyl polymer is the liquid preblend is approximately 1:4 to about 4:1.

25. The method of claim 21 wherein the ingredients are mixed in an extruder.

26. The method of claim 21 wherein the liquid preblended is added with base softeners selected from the group consisting of fats, oils, and emulsifiers.

27. The method of claim 21 wherein the vinyl polymers are chosen from the group consisting of: polyvinyl acetate; polyvinyl stearate; polyvinyl butyrate; polyvinyl propionate; polyvinyl alkanoates; copolymers of vinylacetate, vinyllaurate, vinylacetate and vinylalkanoates; and polymers of ethylene-vinyl acetate, butylene-vinylacetate, and other alkenyl-vinylacetates.

28. A method for producing chewing gum having a modified release rate for one of the components comprising the steps of:
preblending a flavor, a vinyl polymer and a component chosen from the group consisting of a sweetener and a cooling agent; and
adding a resultant liquid preblend with remaining chewing gum ingredients.

29. The method of claim 28 wherein the preblend is added to a gum base portion.

30. The method of claim 28 wherein the ratio of flavor to vinyl polymer is the liquid preblend is approximately 1:4 to about 4:1.

31. The method of claim 28 wherein the vinyl polymers are chosen from the group consisting of: polyvinyl stearate; polyvinyl butyrate; polyvinyl propionate;
polyvinyl alkanoates; copolymers of vinylacetate, vinyllaurate, or vinylacetate and vinylalkanoates; and polymers of ethylene-vinyl acetate, butylene-vinylacetate, and other alkenyl-vinylacetates.
